(19) United States
(12) Patent Application Publication
(10) Pub. No.: US 2014/0005079 A1
(43) Pub. Date: Jan. 2, 2014

(54) Environmentally Friendly Solvent Systems/Surfactant Systems For Drilling Fluids

(71) Applicants: Manilal S. DAHANAYAKE, Princeton Junction, NJ (US); Subramanian KESAVAN, East Windsor, NJ (US); David FLUCK, Elkton, MD (US)

(72) Inventors: Manilal S. DAHANAYAKE, Princeton Junction, NJ (US); Subramanian KESAVAN, East Windsor, NJ (US); David FLUCK, Elkton, MD (US)

(73) Assignee: RHODIA OPERATIONS, Aubervilliers (FR)

(21) Appl. No.: 13/930,111

(22) Filed: Jun. 28, 2013

Related U.S. Application Data
(60) Provisional application No. 61/665,369, filed on Jun. 28, 2012.

(51) Int. Cl. C09K 8/34

(52) U.S. Cl. CPC C09K 8/34
USPC 507/118; 507/136; 507/103; 507/138; 507/129; 507/131; 507/135; 507/139

(57) ABSTRACT

A oil field production fluid, namely a drilling mud composition, comprising a mixture of: (a) at least one base oil component; and (b) an additive component comprising a blend of dibasic esters. The functional fluid can optionally comprise additional additive components. The blend of dibasic esters comprises two or more of dialkyl methylglutarate, dialkyl adipate, dialkyl ethylsuccinate, dialkyl succinate, dialkyl glutarate.

### CROSS-REFERENCE TO RELATED APPLICATIONS

This application claims the benefit of U.S. Provisional Application Ser. No. 61/665,369, filed on Jun. 28, 2012, herein incorporated by reference.

### FIELD OF THE INVENTION

The invention relates to the use of environmentally friendly emulsion systems and compositions for use in oil field production, oil well treatment and related oil field applications, and, in particular, in drilling fluids such as drilling muds and the like.

### BACKGROUND OF THE INVENTION

Oil/petroleum is routinely recovered from subterranean formations or reservoirs through oil wells drilled to appropriate depths within the subterranean formations or reservoirs. In such recovery, various auxiliary fluids are utilized such as spotting fluids, drilling fluids, spacers, packer fluids, workover fluids, stimulation fluids and fracturing fluids. For example drilling fluids, such as drilling muds, are required in the wellbore to lubricate the drill bit, as well as to remove rock fragments in order to transport them to the surface. Drilling fluids are also useful in counterbalancing formation pressure to prevent formation fluids (for example, formation water, oil and gas) from entering the well prematurely and prevent the wellbore from caving in.

Drilling fluids and, in particular, drilling muds can be oil-based, i.e., operate with a continuous oil phase, or water-based, i.e., oil phase is emulsified in a continuous aqueous phase. Water-based drilling muds can have an emulsified oil phase content of up to 50% generally, also referred to as 0/W emulsion muds. Oil-based drilling mud compositions, however, in which the oil constitutes the flowable/continuous phase or else at least a substantial fraction of the flowable phase in the form of a continuous oil phase, can contain amounts of disperse aqueous phase in the range from 5% to 10% to 20% by weight, up to about 40% to 50% to 60% by weight. The non-aqueous phase of such drilling mud systems is formed by what is called the carrier fluid.

Such drilling muds however, face drawbacks such as lack of good emulsifiers/surfactants available, which cause the oil in the drilling muds to separate on to the aqueous phase. The separation of oil on to the surface of the aqueous phase referred to as “sheen”. Such sheen can be harmful to the environment and living organisms, for example, when deposits on the gills of marine organisms, many times causing toxicity and death.

Typical emulsifiers although used do not perform with the environmentally safe base oils, including but not limited to vegetable oil, canola oil, rapeseed oil, synthetic hydrocarbon solvents such as dimeric synthetic lubricants, and the like, which generally are more lypophilic as compared to the conventional base oils. Conventional base oils are in the process of being eliminated due to their toxicity to marine organisms. In another embodiment, the environmentally friendly base oil or base oil component comprises at least one of palm oil, soybean oil, rapeseed oil, high erucic acid rapeseed oil, sunflower seed oil, peanut oil, cottonseed oil, palm kernel oil, linseed oil, coconut oil, olive oil, safflower oil, sesame oil, tung oil, canola oil, castor oil, meadowfoam seed oil, hemp oil.

The toxicity of a mud is generally determined by biological tests in which marine microorganisms are exposed to the ingredients of the mud at different concentrations. The objective is to find mud systems which meet the physical, technical requirements while being of minimal toxicity to the environment.

In use, drilling fluids, including drilling muds, are heated at great depths to high temperatures, up to 250° C. or more; high pressures prevail, and at the same time the compounds in the drilling mud both must remain chemically stable and must not exhibit any severe change in their viscosity behavior, while continuing to form a stable emulsion.

It is therefore desirable to have a drilling fluid, in particular, a drilling mud composition, that is more environmentally friendly that conventional compositions while also maintaining the high performance of conventional compositions.

### SUMMARY OF THE INVENTION

This present invention comprises oil field production and injection fluids, in particular drilling fluids such as drilling muds, which contain one or more branched or linear dibasic esters, wherein the oil field has improved properties including but not limited to lubricity, emulsification, relatively improved environmental profile, as well as improved rheological properties. The dibasic esters utilized described herein present an improved Health, Safety, and Environmental (HSE) profile. They are readily biodegradable, non-flammable (with high flash points), non-toxic, non-irritant and non-sensitizers. They also have a very low vapor pressure (non-VOC per GARB 310 and EU 1999/13/EC), and high boiling points while maintaining low viscosities.

The present invention will become apparent from the following detailed description and examples, which comprises in one aspect, an oil field production fluid comprising a mixture of: (a) at least base oil component; and (b) an additive component comprising a blend of dibasic esters. The base oil component in one embodiment is a environmentally friendly base component or environmentally friendlier base component as compared with oils currently utilized in the industry. Typically the oil field production fluid is a drilling fluid. In some embodiments, the drilling fluid is a drilling mud, lubricating fluid, carrier fluid and the like. The base oil component is typically one or more environmentally friendly base oils, vegetable oil, canola oil, rapeseed oil, synthetic hydrocarbon solvents such as dimeric synthetic lubricants. The oil field production fluid can further comprise one or more additional base oil components. The oil field production fluid can further comprise one or more additional additive components, such as an emulsifier and the like.

The dibasic esters can be derived from adipic, glutaric, and succinic diacids, or isomers thereof. In one particular embodiment, the dibasic ester blend is comprised of a mixture dialkyl methylglutarate, dialkyl ethylsuccinate and, optionally, dialkyl adipate, where the alkyl groups individually comprise C₁-C₁₂ hydrocarbon groups. In another particular embodiment, the dibasic ester blend is comprised of a mixture dialkyl glutarate, dialkyl succinate and dialkyl adipate, where the alkyl groups individually comprise C₁-C₁₂ hydrocarbon groups. In yet another particular embodiment, the dibasic ester blend is comprised of two or more of: dialkyl methylglutarate, dialkyl ethylsuccinate, dialkyl glutarate, dialkyl succinate and dialkyl adipate, where the alkyl groups individually comprise C₁-C₁₂ hydrocarbon groups.

In one embodiment, the blend of dibasic esters comprises (i) a dialkyl methylglutarate and (ii) a dialkyl ethylsuccinate. In another embodiment, the blend of dibasic esters comprises dialkyl adipate, dialkyl methylglutarate and dialkyl ethylsuccinate.

In one embodiment, the blend of dibasic esters comprises:

(i) from about 5-25%, by weight of the blend, a first dibasic ester of formula:

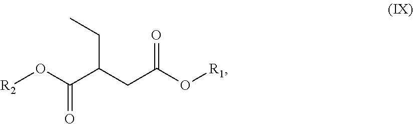

(ii) from about 70-95%, by weight of the blend, a second dibasic ester of formula:

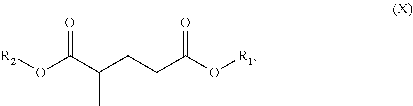

and

(iii) optionally, from about 0-5% by weight of the blend, a third dibasic ester of formula:

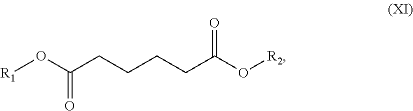

wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl. In another embodiment, R₁ and R₂ are hydrocarbon groups individually selected from methyl, ethyl, propyl, isopropyl, n-butyl, pentyl, isoamyl, hexyl, heptyl or octyl. In one embodiment, the blend of dibasic esters is characterized by vapor pressure of less than about 10 Pa.

In one embodiment, the blend of dibasic esters comprises:

(i) from about 20-28%, by weight of the blend, a first dibasic ester of formula:

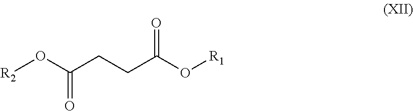

(ii) from about 59-67%, by weight of the blend, a second dibasic ester of formula:

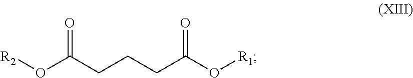

and

(iii) from about 9-17%, by weight of the blend, a third dibasic ester of formula:

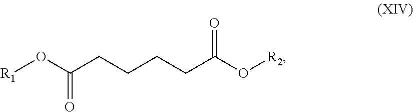

wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl. In one embodiment, R₁ and R₂ are hydrocarbon groups individually selected from methyl, ethyl, propyl, isopropyl, n-butyl, pentyl, isoamyl, hexyl, heptyl or octyl. In another embodiment, R₁ and R₂ are individually selected from branched, linear and/or cyclic C₁-C₁₀ hydrocarbon groups.

In one embodiment, the additive component constitutes less than about 50% by weight of the oil field production fluid. In another embodiment, the additive component is present in an amount greater than about 0.1%, 0.5%, 1%, 2%, 4%, 5%, 10%, 15%, 20%, 25% or 50% by weight of the oil field production fluid such as a drilling mud.

In another aspect, described herein are methods of increasing lubricity, emulsification, rheological profile or other properties of an oil field production fluid such as a drilling mud, by contacting an effective amount of one or more blend of dibasic esters with the oil field production fluid. It has been observed that the dibasic ester blend does not increase the viscosity of the oil field production fluid, and as such, one can better control the rheology of such production fluid. In conventional production fluids, surfactants used to emulsify oils in the fluid affect, sometimes significantly, the viscosity of the production fluid, which is often not desirable.

The dibasic esters described herein are environmentally friendly (including but not limited to being non toxic, bio-degradable, non-flammable and the like), with a high flash point, low vapor pressure and low odor; falls under the consumer products LVP-VOC exemption criteria established by GARB and the EPA (GARB 310 and EU 1999/13/EC).

### DETAILED DESCRIPTION

As used herein, the term “alkyl” means a saturated straight chain, branched chain, or cyclic hydrocarbon radical, including but not limited to, methyl, ethyl, n-propyl, iso-propyl, n-butyl, sec-butyl, t-butyl, pentyl, n-hexyl, and cyclohexyl.

As used herein, the term “aryl” means a monovalent unsaturated hydrocarbon radical containing one or more six-membered carbon rings in which the unsaturation may be represented by three conjugated double bonds, which may be substituted one or more of carbons of the ring with hydroxy, alkyl, alkenyl, halo, haloalkyl, or amino, including but not limited to, phenoxy, phenyl, methylphenyl, dimethylphenyl, trimethylphenyl, chlorophenyl, trichloromethylphenyl, aminophenyl, and tristyrylphenyl.

As used herein, the term “alkylene” means a divalent saturated straight or branched chain hydrocarbon radical, such as for example, methylene, dimethylene, trimethylene.

As used herein, the terminology “(Cᵣ-Cₛ)” in reference to an organic group, wherein r and s are each integers, indicates that the group may contain from r carbon atoms to s carbon atoms per group.

Described herein are oil field production fluids comprising a mixture of: (a) at least one base oil component; and (b) an additive component comprising a blend of dibasic esters. In one embodiment, the oil field production fluid further comprises (c) at least one emulsifier. The base oil component(s) are typically environmentally friendly base oils, vegetable oil, canola oil, rapeseed oil, synthetic hydrocarbon solvents such as dimeric synthetic lubricants, and the like. Generally, the base oil component comprises one or more oils that are more lypophilic compared to conventional base oils currently used in the industry.

These oil field production fluids usually have to operate under extreme temperature ranges. Dibasic esters can also function as an emulsifier, lubricant and/or a carrier fluid in these kinds of systems and temperature ranges. In one embodiment, the branched dibasic esters described herein and used as an additive component in production fluids, have higher and sharper boiling range with a lower freezing point, relative to linear dibasic esters. In addition IRIS-based dibasic esters (as described herein) have shown to enhance lubricity in non-polar fluids.

The dibasic esters, including when utilized as an additive component, described herein have desirable qualities including one or a combination of: being substantially non-toxic, being non-flammable, being readily biodegradable, having a high flash point, having low vapor pressure, having low odor, and meeting the consumer products LVP-VOC exemption criteria established by CARB and the EPA, such as CARB 310 and the EU 1999/13/EC.

The base oil component may be a synthetic component, a petroleum-derived component, or a biologically-derived component, which is environmentally less toxic and/or environmentally friendly as compared to conventional base oils. In one embodiment, the base oil is one or a combination of two or more of the synthetic component, the petroleum-derived component, and/or the biologically-derived component. Petroleum-derived base oils are sometimes referred to as mineral oils, and is often used in developing functional fluids. Synthetic base oils are usually products of petroleum-derived organic chemicals, and can be used for extreme applications where petroleum-derived base oils fail or are ineffective. The biologically-derived component can include vegetable oils and animal fats, which are sometimes utilized to formulate environmentally compatible functional fluids.

In one embodiment, the oil field production fluid further comprises an emulsifier. The emulsifier can be any number of cationic, amphoteric, zwitterionic, anionic or nonionic surfactants, derivatives thereof, as well as blends of such surfactants. Typically, the emulsifier is a nonionic surfactant.

Besides the base oil component, functional fluids can also contain an additive component. The additive component serve a purpose by improving or enhancing one or more of the properties already present in the base oil component, or by adding new properties to the base oil component. Additive components added to the base oil component include but are not limited to demulsifiers, dispersants, pour point depressants, thermal stabilizers, anti-leak agents, detergents, agents to improve shelf stability, lubricity agents, extreme pressure agents, agents to improve low temperature performance, friction modifiers, anti-wear agents, oxidation inhibitors, environmental profile, rust inhibiting agents, corrosion inhibitors, emulsifiers, anti-foam agents, and rheology and viscosity modifiers.

In one embodiment, the additive component is less than about 50% by weight of the oil field production fluid. In another embodiment, the additive component is less than about 25% by weight of the oil field production fluid. In yet another embodiment, the additive component is less than about 15% by weight of the oil field production fluid. In a further embodiment, the additive component is less than about 10% by weight of the oil field production fluid. In another embodiment, the additive component is less than about 5% by weight of the oil field production fluid. Typically, the additive component comprises a blend of dibasic esters.

In one embodiment, the blend comprises adducts of alcohol and linear diacids, the adducts having the formula R₁—OOC-A-COO—R₂ wherein R₁ and/or R₂ comprise, individually, a C₁-C₁₂ alkyl, more typically a C₁-C₈ alkyl, and A comprises a mixture of —(CH₂)₄—, —(CH₂)₃, and —(CH₂)₂—. In another embodiment, R₁ and/or R₂ comprise, individually, a C₄-C₁₂ alkyl, more typically a C₄-C₈ alkyl. In one embodiment, R₁ and R₂ can individually comprise a hydrocarbon group originating from fusel oil. In one embodiment, R₁ and R₂ individually can comprise a hydrocarbon group having 1 to 8 carbon atoms. In one embodiment, R₁ and R₂ individually can comprise a hydrocarbon group having 5 to 8 carbon atoms.

In one embodiment, the blend comprises adducts of alcohol and branched or linear diacids, the adducts having the formula R1-OOC-A-COO—R2 wherein R1 and/or R2 comprise, individually, a C1-C12 alkyl, more typically a C₁-C8 alkyl, and A comprises a mixture of —(CH2)4-, —CH2CH2CH(CH3)-, and —CH2CH(C2H5)-. In another embodiment, R1 and/or R2 comprise, individually, a C4-C12 alkyl, more typically a C4-C8 alkyl. It is understood that the acid portion may be derived from such dibasic acids such as adipic, succinic, glutaric, oxalic, malonic, pimelic, suberic and azelaic acids, as well as mixtures thereof.

One or more dibasic esters described herein can be prepared by any appropriate process. For example, a process for preparing the adduct of adipic acid and of fusel oil is, for example, described in the document “The Use of Egyptian Fusel Oil for the Preparation of Some Plasticizers Compatible with Polyvinyl Chloride”, Chuiba et al., Indian Journal of Technology, Vol. 23, August 1985, pp. 309-311.

The dibasic esters described herein can be obtained by a process comprising an “esterification” stage by reaction of a diacid of formula HOOC-A-COOH or of a diester of formula MeOOC-A-COOMe with a branched alcohol or a mixture of alcohols. The reactions can be appropriately catalyzed. Use is preferably made of at least 2 molar equivalents of alcohols per diacid or diester. The reactions can, if appropriate, be promoted by extraction of the reaction by-products and followed by stages of filtration and/or of purification, for example by distillation.

The diacids in the form of mixtures can in particular be obtained from a mixture of dinitrile compounds in particular produced and recovered in the process for the manufacture of adiponitrile by double hydrocyanation of butadiene. This process, used on a large scale industrially to produce the greater majority of the adiponitrile consumed worldwide, is described in numerous patents and works. The reaction for the hydrocyanation of butadiene results predominantly in the formulation of linear dinitriles but also in formation of branched dinitriles, the two main ones of which are methylglutaronitrile and ethylsuccinonitrile. The branched dinitrile compounds are separated by distillation and recovered, for example, as top fraction in a distillation column, in the stages for separation and purification of the adiponitrile. The branched dinitriles can subsequently be converted to diacids or diesters (either to light diesters, for a subsequent transesterification reaction with the alcohol or the mixture of alcohols or the fusel oil, or directly to diesters in accordance with the invention). For example, the blend of dibasic esters is derived or taken from the methylglutaronitrile product stream in the manufacture of adiponitrile.

Dibasic esters described herein can be derived from one or more by-products in the production of polyamide, for example, polyamide 6,6. In one embodiment, the cleaning composition comprises a blend of linear or branched, cyclic or noncyclic, C₁-C₂₀ alkyl, aryl, alkylaryl or arylalkyl esters of adipic diacids, glutaric diacids, and succinic diacids. In another embodiment, the cleaning composition comprises a blend of linear or branched, cyclic or noncyclic, C₁-C₂₀ alkyl, aryl, alkylaryl or arylalkyl esters of adipic diacids, methylglutaric diacids, and ethylsuccinic diacids

Generally, polyamide is a copolymer prepared by a condensation reaction formed by reacting a diamine and a dicarboxylic acid. Specifically, polyamide 6,6 is a copolymer prepared by a condensation reaction formed by reacting a diamine, typically hexamethylenediamine, with a dicarboxylic acid, typically adipic acid.

In one embodiment, the blend of the present invention can be derived from one or more by-products in the reaction, synthesis and/or production of adipic acid utilized in the production of polyamide, the cleaning composition comprising a blend of dialkyl esters of adipic diacids, glutaric diacids, and succinic diacids (herein referred to sometimes as “AGS” or the “AGS blend”). In one embodiment, the blend of esters is derived from by-products in the reaction, synthesis and/or production of hexamethylenediamine utilized in the production of polyamide, typically polyamide 6,6. In one embodiment, the blend of dibasic esters is derived or taken from the methylglutaronitrile product stream in the manufacture of adiponitrile; the cleaning composition comprises a blend of dialkyl esters of methylglutaric diacids, ethylsuccinic diacids and, optionally, adipic diacids (herein referred to sometimes as “MGA”, “MGN”, “MGN blend” or “MGA blend”).

The boiling point of the dibasic ester blend of the present invention is between the range of about 120° C. to 450° C. In one embodiment, the boiling point of the blend of the present invention is in the range of about 160° C. to 400° C.; in one embodiment, the range is about 210° C. to 290° C.; in another embodiment, the range is about 210° C. to 245° C.; in another embodiment, the range is the range is about 215° C. to 225° C. In one embodiment, the boiling point range of the blend of the present invention is between about 210° C. to 390° C., more typically in the range of about 280° C. to 390° C., more typically in the range of 295° C. to 390° C. In one embodiment, boiling point of the blend of the present invention is in the range of about 215° C. to 400° C., typically in the range of about 220° C. to 350° C.

In one embodiment, the blend of dibasic esters has a boiling point range of between about 300° C. and 330° C. Typically, the diisoamyl AGS blend is associated with this boiling point range. In another embodiment, the dibasic ester blend of the present invention has a boiling point range of between about 295° C. and 310° C. Typically, the di-n-butyl AGS blend is associated with this boiling point range. Generally, a higher boiling point, typically, above 215° C., or high boiling point range corresponds to lower VOC.

According to one embodiment of the present invention, the blend of dibasic esters corresponds to one or more by-products of the preparation of adipic acid, which is one of the main monomers in polyamides. For example, the dialkyl esters are obtained by esterification of one by-product, which generally contains, on a weight basis, from 15 to 33% succinic acid, from 50 to 75% glutaric acid and from 5 to 30% adipic acid. As another example, the dialkyl esters are obtained by esterification of a second by-product, which generally contains, on a weight basis, from 30 to 95% methyl glutaric acid, from 5 to 20% ethyl succinic acid and from 1 to 10% adipic acid. It is understood that the acid portion may be derived from such dibasic acids such as, adipic, succinic, glutaric, oxalic, malonic, pimelic, suberic and azelaic acids, as well as mixtures thereof.

In some embodiments, the dibasic ester blend comprises adducts of alcohol and linear diacids, the adducts having the formula R—OOC-A-COO—R wherein R is ethyl and A is a mixture of —(CH₂)₄—, —(CH₂)₃, and —(CH₂)₂—. In other embodiments, the blend comprises adducts of alcohol, typically ethanol, and linear diacids, the adducts having the formula R¹—OOC-A-COO—R², wherein at least part of R¹ and/or R² are residues of at least one linear alcohol having 4 carbon atoms, and/or at least one linear or branched alcohol having at least 5 carbon atoms, and wherein A is a divalent linear hydrocarbon. In some embodiments A is one or a mixture of —(CH₂)₄—, —(CH₂)₃, and —(CH₂)₂—.

In another embodiment, the R¹ and/or R² groups can be linear or branched, cyclic or noncyclic, C₁-C₂₀ alkyl, aryl, alkylaryl or arylalkyl groups. Typically, the R¹ and/or R² groups can be C₁-C₈ groups, for example groups chosen from the methyl, ethyl, n-propyl, isopropyl, n-butyl, n-amyl, n-hexyl, cyclohexyl, 2-ethylhexyl and isooctyl groups and their mixtures. For example, R¹ and/or R² can both or individually be ethyl groups, R¹ and/or R² can both or individually be n-propyl groups, R¹ and/or R² can both or individually be isopropyl groups, R¹ and/or R² can both or individually be n-butyl groups, R¹ and/or R² can both or individually be iso-amyl groups, R¹ and/or R² can both or individually be n-amyl groups, or R¹ and/or R² can be mixtures thereof (e.g., when comprising a blend of dibasic esters).

In further embodiments the invention can include blends comprising adducts of branched diacids, the adducts having the formula R³—OOC-A-COO—R⁴ wherein R³ and R⁴ are the same or different alkyl groups and A is a branched or linear hydrocarbon. Typically, A comprises an isomer of a O₄ hydrocarbon. Examples include those where R³ and/or R⁴ can be linear or branched, cyclic or noncyclic, C₁-C₂₀ alkyl, aryl, alkylaryl or arylalkyl groups. Typically, R³ and R⁴ are independently selected from the group consisting of methyl, ethyl, propyl, isopropyl, butyl, n-butyl, iso-butyl, iso-amyl, and fusel.

In yet another embodiment, the invention comprises a composition based on dicarboxylic acid diester(s) of formula R⁵—OOC-A-COO—R⁶ wherein group A represents a divalent alkylene group typically in the range of, on average, from 2.5 to 10 carbon atoms. R⁵ and R⁶ groups, which can be identical or different, represent a linear or branched, cyclic or noncyclic, C₁-C₂₀ alkyl, aryl, alkylaryl or an arylalkyl group.

The blend can correspond to a complex reaction product, where mixtures of reactants are used. For example, the reaction of a mixture of HOOC-A^{a}-COOH and HOOC-A^{b}-COOH with an alcohol R^{a}—OH can give a mixture of the products R^{a}OOC-A^{a}-COOR^{a} and R^{a}OOC-A^{b}-COOR^{a}. Likewise, the reaction of HOOC-A^{a}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b} and R^{b}OOC-A^{a}-COOR^{a} (different from R^{a}OOC-A^{a}-COOR^{b} if A^{a} is not symmetrical). Likewise, the reaction of a mixture of HOOC-A^{a}-COOH and HOOC-A^{b}-COOH with a mixture of alcohols R^{a}—OH and R^{b}—OH can give a mixture of the products R^{a}OOC-A^{a}-COOR^{a} and R^{b}OOC-A^{a}-COOR^{b}, R^{a}OOC-A^{a}-COOR^{b}, R^{b}OOC-A^{a}-COOR^{a} (different from R^{a}OOC-A^{a}-COOR^{b} if A^{a} is not symmetrical), R^{a}OOC-A^{b}-COOR^{a} and R^{b}OOC-A^{b}-COOR^{b}, R^{a}OOC-A^{b}-COOR^{b} and R^{b}OOC-A^{b}-COOR^{a} (different from R^{a}OOC-A^{b}-COOR^{b} if A^{b} is not symmetrical).

The groups R¹ and R², can correspond to alcohols R¹—OH and R²—OH (respectively). These groups can be likened to the alcohols. The group(s) A, can correspond to one or more dicarboxylic acid(s) HOOC-A-COOH. The group(s) A can be likened to the corresponding diacid(s) (the diacid comprises 2 more carbon atoms than the group A).

In one embodiment, group A is a divalent alkylene group comprising, on average, more than 2 carbon atoms. It can be a single group, with an integral number of carbon atoms of greater than or equal to 3, for example equal to 3 or 4. Such a single group can correspond to the use of a single acid. Typically, however, it corresponds to a mixture of groups corresponding to a mixture of compounds, at least one of which exhibits at least 3 carbon atoms. It is understood that the mixtures of groups A can correspond to mixtures of different isomeric groups comprising an identical number of carbon atoms and/or of different groups comprising different numbers of carbon atoms. The group A can comprise linear and/or branched groups.

According to one embodiment, at least a portion of the groups A corresponds to a group of formula —(CH₂)ₙ— where n is a mean number greater than or equal to 3. At least a portion of the groups A can be groups of formula —(CH₂)₄— (the corresponding acid is adipic acid). For example, A can be a group of formula —(CH₂)₄—, and/or a group of formula —(CH₂)₃—.

In one embodiment, the composition comprises compounds of formula R—OOC-A-COO—R where A is a group of formula —(CH₂)₄—, compounds of formula R—OOC-A-COO—R where A is a group of formula —(CH₂)₃—, and compounds of formula R—OOC-A-COO—R where A is a group of formula —(CH₂)₂—.

In certain embodiments, the dibasic ester blend comprises:

a diester of formula I:

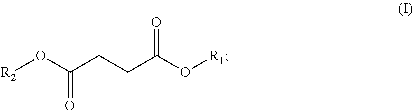

a diester of formula II:

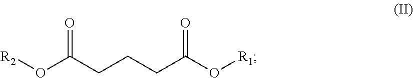

and

a diester of formula III:

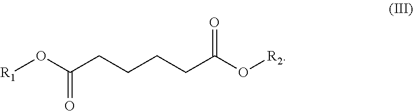

R₁ and/or R₂ can individually comprise a hydrocarbon having from about 1 to about 8 carbon atoms, typically, methyl, ethyl, propyl, isopropyl, butyl, isobutyl, n-butyl, isoamyl, hexyl, heptyl or octyl. In such embodiments, the blend typically comprises (by weight of the blend) (i) about 15% to about 35% of the diester of formula I, (ii) about 55% to about 70% of the diester of formula II, and (iii) about 7% to about 20% of the diester of formula III, and more typically, (i) about 20% to about 28% of the diester of formula I, (ii) about 59% to about 67% of the diester of formula II, and (iii) about 9% to about 17% of the diester of formula III. The blend is generally characterized by a flash point of 98° C., a vapor pressure at 20° C. of less than about 10 Pa, and a distillation temperature range of about 200-300° C. Mention may also be made of Rhodiasolv® RPDE (Rhodia Inc., Cranbury, N.J.), Rhodiasolv® DIB (Rhodia Inc., Cranbury, N.J.) and Rhodiasolv® DEE (Rhodia Inc., Cranbury, N.J.).

In certain other embodiments, the dibasic ester blend comprises:

a diester of the formula IV:

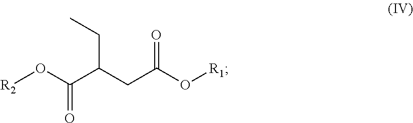

a diester of the formula V:

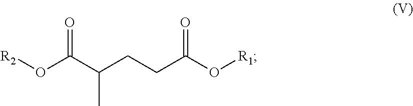

and

optionally, a diester of the formula VI:

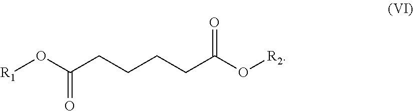

R₁ and/or R₂ can individually comprise a hydrocarbon having from about 1 to about 13 carbon atoms, typically, methyl, ethyl, propyl, isopropyl, butyl, isobutyl, n-butyl, isoamyl, hexyl, heptyl, or octyl. In such embodiments, the blend typically comprises (by weight of the blend) (i) from about 5% to about 30% of the diester of formula IV, (ii) from about 70% to about 95% of the diester of formula V, and (iii) from about 0% to about 10% of the diester of formula VI. More typically, the blend typically comprises (by weight of the blend): (i) from about 6% to about 12% of the diester of formula IV, (ii) from about 86% to about 92% of the diester of formula V, and (iii) from about 0.5% to about 4% of the diester of formula VI.

Most typically, the blend comprises (by weight of the blend): (i) about 9% of the diester of formula IV, (ii) about 89% of the diester of formula V, and (iii) about 1% of the diester of formula VI. The blend is generally characterized by a flash point of 98° C., a vapor pressure at 20° C. of less than about 10 Pa, and a distillation temperature range of about 200-275° C. Mention may be made of Rhodiasolv® IRIS and Rhodiasolv® DEE/M, manufactured by Rhodia Inc. (manufactured by Rhodia Inc., Cranbury, N.J.)

In yet another embodiment, the dibasic ester blend can be any combination of formula (I), formula (II), formula (III), formula (IV), formula (V) and/or formula (VI).

In one embodiment, the nonionic surfactants generally includes one or more of for example amides such as alkanolamides, ethoxylated alkanolamides, ethylene bisamides; esters such as fatty acid esters, glycerol esters, ethoxylated fatty acid esters, sorbitan esters, ethoxylated sorbitan; ethoxylates such as alkylphenol ethoxylates, alcohol ethoxylates, tristyrylphenol ethoxylates, mercaptan ethoxylates; end-capped and EO/PO block copolymers such as ethylene oxide/propylene oxide block copolymers, chlorine capped ethoxylates, tetra-functional block copolymers; amine oxides such lauramine oxide, cocamine oxide, stearamine oxide, stearamidopropylamine oxide, palmitamidopropylamine oxide, decylamine oxide; fatty alcohols such as decyl alcohol, lauryl alcohol, tridecyl alcohol, myristyl alcohol, cetyl alcohol, stearyl alcohol, oleyl alcohol, linoleyl alcohol and linolenyl alcohol; and alkoxylated alcohols such as ethoxylated lauryl alcohol, trideceth alcohols; and fatty acids such as lauric acid, oleic acid, stearic acid, myristic acid, cetearic acid, isostearic acid, linoleic acid, linolenic acid, ricinoleic acid, elaidic acid, arichidonic acid, myristoleic acid, as well as mixtures thereof. In another embodiment, the non-ionic surfactant is a glycol such as polyethylene glycol (PEG), alkyl PEG esters, polypropylene glycol (PPG) and derivatives thereof. In certain embodiments, the surfactant is a blend of: one or more alcohol ethoxylates, one or more alkyl phenol ethoxylates, one or more terpene alkoxylates, or any mixture thereof. In one exemplary embodiment, the surfactant is a C₆-C₁₃ alcohol ethoxylate and, more typically, a C₈-C₁₂ alcohol ethoxylate.

Experiments

In the following experiment, the drilling mud utilized is a 14 lb/gal density mud containing barite as a weighting agent, xanthan for viscosifier and caustic as a pH adjuster.

Determining “sheen”: visible observation of amount of oil visible from the surface
not much oil visible is considered a pass
too much oil on surface is considered a fail Plastic viscosity—measured using Fann 35 or equivalent

PV=(shear stress @ 1022/sec-shear stress @ 511/sec)/510

YP=shear stress @ 511/sec —PV*511

Typically, shear stress @ 1022/sec is measured using Fann 35 @ 600 rpm with R1B1 bob

Typically, Shear stress @ 511/sec is measured using Fann 35 @ 300 rpm with R1B1 bob

TABLE 1
Table 1

| | Emulsifier package | | | | |
|---|---|---|---|---|---|
| | (% by volume) | | | | |
| | Blend 1 | Blend 2 | Blend 3 | Blend 4 | Blend 5 |
| Igepal CO-430 | 0.90% | 0.60% | 1.75% | 0.90% | |
| Igepal CO-530 | 0.60% | 0.40% | | 0.60% | |
| Alkamuls SMO | | | | | 1.50% |
| Rhodiasolv | | 0.50% | 0.50% | 0.50% | 0.50% |
| IRIS | | | | | |
| base oil TX-3b | 98.50% | 98.50% | | | |
| synfluid dimer | | | 97.75% | 98.50% | |
| C10 | | | | | |
| synfluid dimer | | | | | |
| C12 | | | | | |
| synfluid dimer | | | | | 98% |
| C20/24 | | | | | |

TABLE 2

| | | | PV | |
|---|---|---|---|---|
| | | | (plastic | YP (yield |
| | | Sheen | visc.) | point) |
| Test 1 | 94% drilling mud, 6% blend 1 | fail | 49 | 13 |
| Test 2 | 94% drilling mud, 6% blend 2 | Pass | 51 | 9 |
| Test 3 | 94% drilling mud, 6% blend 3 | Pass | 53 | 20 |
| Test 4 | 86% drilling mud, 14% blend 3 | Pass | 53 | 21 |
| Test 5 | 94% drilling mud, 6% blend 4 | Pass | 49 | 13 |
| Test 6 | 86% drilling mud, 14% blend 4 | Pass | 53 | 24 |
| Test 7 | 94% drilling mud, 6% blend 5 | Pass | 49 | 13 |
| Test 8 | 86% drilling mud, 14% blend 5 | Pass | 51 | 22 |

Igepal CO is a nonyl phenol ethoxylate and Alkamus SMO is sorbitan monooleate. The present invention, therefore, is well adapted to carry out the objects and attain the ends and advantages mentioned, as well as others inherent therein. While the invention has been depicted and described and is defined by reference to particular preferred embodiments of the invention, such references do not imply a limitation on the invention, and no such limitation is to be inferred. Consequently, the invention is intended to be limited only by the spirit and scope of the appended claims, giving full cognizance to equivalents in all respects.

1. An additive composition for use in a drilling fluid composition comprising (i) dialkyl methylglutarate and (ii) dialkyl ethylsuccinate, wherein the alkyl groups individually comprise C₁-C₁₂ hydrocarbon groups.

2. The additive composition of claim 1 wherein the drilling fluid is a drilling mud.

3. The additive composition of claim 1 further comprising at least one dibasic ester comprising dialkyl adipate, dialkyl succinate, dialkyl glutarate or any combination thereof.

4. The composition of claim 1 further comprising at least one additional component.

5. The composition of claim 1 further comprising at least one emulsifier.

6. The composition of claim 1 wherein the emulsifier comprises at least one alcohol ethoxylate, at least one alkyl phenol ethoxylate, at least one terpene alkoxylate, or any mixture thereof.

7. The additive composition of claim 1 wherein the additive composition is present in an amount greater than about 0.1%, 0.5%, 1%, 2%, 4%, 5%, 10%, 15%, 20%, 25% or 50% by weight of the drilling fluid composition.

8. An oil-based drilling fluid composition comprising:
a) at least one environmentally friendly base oil;
b) a blend of dibasic esters; and
c) optionally, at least one emulsifier.

9. The composition of claim 8 wherein the blend of dibasic esters comprises dialkyl methylglutarate and dialkyl ethylsuccinate, and wherein the alkyl groups individually comprise C₁-C₁₂ hydrocarbon groups.

10. The composition of claim 8 wherein the blend of dibasic esters is selected from the group consisting of dialkyl methylglutarate, dialkyl adipate, dialkyl ethylsuccinate, dialkyl succinate, dialkyl glutarate and any combination thereof, and wherein the alkyl groups individually comprise C₁-C₁₂ hydrocarbon groups.

11. The composition of claim 8 wherein the blend of dibasic esters is present in an amount greater than about 0.1%, 0.5%, 1%, 2%, 4%, 5%, 10%, 15%, 20%, 25% or 50% by weight of the composition.

12. The composition of claim 8 wherein the drilling fluid is a drilling mud, lubricating fluid or carrier fluid.

13. The composition of claim 8 wherein the at least one environmentally friendly base oil comprises vegetable oil, canola oil, rapeseed oil, synthetic hydrocarbon solvents, dimeric synthetic lubricants or a mixture thereof.

14. The composition of claim 8 wherein the drilling fluid is oil-based, semi-synthetic based, or water-based.

15. The composition of claim 8 further comprising at least one additional component.

16. The composition of claim 8 wherein the emulsifier comprises at least one alcohol ethoxylate, at least one alkyl phenol ethoxylate, at least one terpene alkoxylate, or any mixture thereof.

17. The composition of claim 8 wherein the emulsifier comprises one or more amides, alkanolamides, ethoxylated alkanolamides, ethylene bisamides, esters, fatty acid esters, glycerol esters, ethoxylated fatty acid esters, sorbitan esters, ethoxylated sorbitan, ethoxylates, alkylphenol ethoxylates, alcohol ethoxylates, tristyrylphenol ethoxylates, mercaptan ethoxylates, end-capped and EO/PO block copolymers, ethylene oxide/propylene oxide block copolymers, chlorine capped ethoxylates, tetra-functional block copolymers, amine oxides, lauramine oxide, cocamine oxide, stearamine oxide, stearamidopropylamine oxide, palmitamidopropylamine oxide, decylamine oxide, fatty alcohols, decyl alcohol, lauryl alcohol, tridecyl alcohol, myristyl alcohol, cetyl alcohol, stearyl alcohol, oleyl alcohol, linoleyl alcohol, linolenyl alcohol, alkoxylated alcohols, ethoxylated lauryl alcohol, trideceth alcohols, fatty acids, lauric acid, oleic acid, stearic acid, myristic acid, cetearic acid, isostearic acid, linoleic acid, linolenic acid, ricinoleic acid, elaidic acid, arichidonic acid, myristoleic acid, as well as mixtures thereof.

18. The composition of claim 8 wherein the blend of dibasic esters comprises:
(i) from about 5-25%, by weight of the blend, a first dibasic ester of formula: 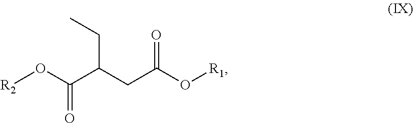
(ii) from about 70-95%, by weight of the blend, a second dibasic ester of formula: 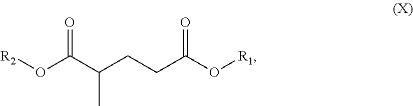
and
(iii) optionally, from about 0-5%, by weight of the blend, a third dibasic ester of formula: 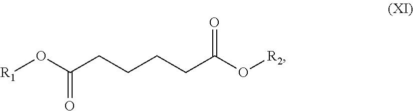
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.

19. The composition of claim 18, further comprising at least one additional dibasic ester selected from the group consisting of:
(i) a dibasic ester of formula XII: 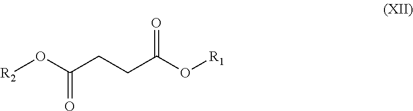
(ii) a dibasic ester of formula XIII: 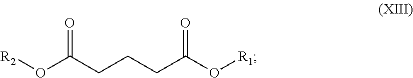
(iii) a dibasic ester of formula XIV: 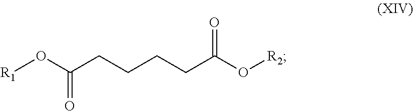
and
(iv) any combination thereof,
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.

20. A method of formulating a drilling mud composition comprising:
a) obtaining an environmentally friendly base oil; and
b) contacting a blend of dibasic esters with the base oil.

21. The method of claim 20 wherein the blend of dibasic esters comprises dialkyl methylglutarate and dialkyl ethylsuccinate, and wherein the alkyl groups individually comprise C₁-C₁₂ hydrocarbon groups.

22. The method of claim 20 wherein the blend of dibasic esters is selected from the group consisting of dialkyl methylglutarate, dialkyl adipate, dialkyl ethylsuccinate, dialkyl succinate, dialkyl glutarate and any combination thereof, and wherein the alkyl groups individually comprise C₁-C₁₂ hydrocarbon groups.

23. The method of claim 20 further comprising the step of contacting with the base oil at least one additional component.

24. The method of claim 20 wherein the blend of dibasic esters comprises:
(i) from about 5-25%, by weight of the blend, a dibasic ester of formula IX: 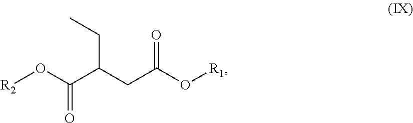
(ii) from about 70-95%, by weight of the blend, a dibasic ester of formula X: 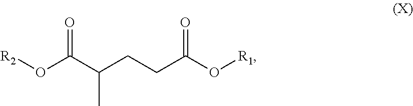
and
(iii) optionally, from about 0-5%, by weight of the blend, a dibasic ester of formula XI: 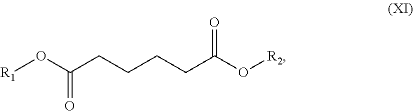
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.

25. The composition of claim 24, further comprising at least one additional dibasic ester selected from the group consisting of:
(i) a dibasic ester of formula XII: 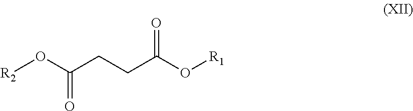
(ii) a dibasic ester of formula XIII: 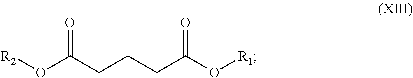
(iii) a dibasic ester of formula XIV: 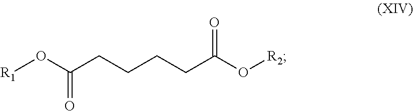
and
(iv) any combination thereof,
wherein R₁ and R₂ are hydrocarbon groups individually selected from C₁-C₁₃ alkyl, C₁-C₁₃ aryl, C₁-C₁₃ alkaryl, C₁-C₁₃ alkoxy, C₁-C₁₃ alkylarylalkyl, C₁-C₁₃ arylalkyl, C₁-C₁₃ alkylamidoalkyl or C₁-C₁₃ alkylaminoalkyl.
